(19) United States
(12) Patent Application Publication
(10) Pub. No.: US 2013/0173655 A1
(43) Pub. Date: Jul. 4, 2013

(54) SELECTIVE FETCHING OF SEARCH RESULTS

(71) Applicants: Harry L. Hoots III, III, Raleigh, NC (US); Timothy W. Owings, Lake Worth, FL (US)

(72) Inventors: Harry L. Hoots III, III, Raleigh, NC (US); Timothy W. Owings, Lake Worth, FL (US)

(73) Assignee: INTERNATIONAL BUSINESS MACHINES CORPORATION, Armonk, NY (US)

(21) Appl. No.: 13/343,289

(22) Filed: Jan. 4, 2012

(51) Int. Cl. G06F 17/30

(52) U.S. Cl. 707/769; 707/E17.014

(57) ABSTRACT

A method, program product and system for selectively fetching search results data. Once a search query has been received and executed in a database, the total count of search results are divided into pages. A computer fetches a determined number of pages of search results data and stores the search results data in a repository. The computer displays one page of fetched search results data and links to other pages of search results data to the user through the interface. If the user selects a page of search results data to display which was not already fetched, the computer fetches the non-fetched search results data and marks the fetched search results data. The marked data may be discarded or cached through memory virtualization.

### BACKGROUND

The present invention relates to selective fetching of search results, and more specifically to displaying and fetching only a portion of the search results to a user.

In some Internet searching situations, users enter in a broad search query that returns a very large number of search results. Retrieving a large number of search results from a database can cause a user's device to take an extended period of time to return the search results, use significant amounts of memory of the user's device and cache a large amount of data in the browser interface of the user's device, leading to possible memory errors and time-outs. Furthermore most users only ever view a small number of the results that are retrieved in response to a search query.

### SUMMARY

According to one embodiment of the present invention, a method for selectively fetching search results data. The method includes the steps of: a computer receiving a search query from a user through an interface and storing the search query in a repository; the computer performing a search in a database and receiving a total count of the search results data that matches the query; the computer dividing the total count of the search results data that matches the query into pages; the computer determining how many pages of search results data to fetch; the computer fetching search results data for the determined number of pages and store the determined number of pages in the repository; the computer displaying one page of fetched search results data and links to other pages of search results data to the user through the interface; accepting an action from the user selecting a page of search results data to display from the links to other pages of search results data through the interface; if the action selects a page of search results data which was not fetched, the computer fetching at least one page of non-fetched search results data and marking the search results data of the page of the fetched search results data; and repeating the method from the step of the computer displaying one page of fetched search results data and links to other pages of search results data to the user through the interface.

According to another embodiment of the present invention, a computer program product for selectively fetching search results. The computer program product including one or more computer-readable, tangible storage devices; program instructions, stored on at least one of the one or more storage devices, to receive a search query from a user through an interface and store the search query in a repository; program instructions, stored on at least one of the one or more storage devices, to perform a search in a database and receive a total count of the search results data that matches the query; program instructions, stored on at least one of the one or more storage devices, to divide the total count of the search results data that matches the query into pages; program instructions, stored on at least one of the one or more storage devices, to determine how many pages of search results data to fetch; program instructions, stored on at least one of the one or more storage devices, to fetch search results data for the determined number of pages and store the search results data for the determined number of pages in the repository; program instructions, stored on at least one of the one or more storage devices, to display one page of fetched search results data and links to other pages of search results data to the user through the interface; program instructions, stored on at least one of the one or more storage devices, to accept an action from the user selecting a page of search results data to display from the links to other pages of search results data to the user through the interface; if the action selects a page of search results data which was not fetched, program instructions, stored on at least one of the one or more storage devices, to fetch at least one page of non-fetched search results data and store in the repository and mark the search results data of the page of fetched search results data; and repeating from the program instructions, stored on at least one of the one or more storage devices, to display the at least one page of fetched search results data and links to pages of search results data to the user through the interface.

According to another embodiment of the present invention, a system for selectively fetching search results. The system including: one or more processors, one or more computer-readable memories and one or more computer-readable, tangible storage devices; program instructions, stored on at least one of the one or more storage devices for execution by at least one of the one or more processors via at least one of the one or more memories, to receive a search query from a user through an interface and store the search query in a repository; program instructions, stored on at least one of the one or more storage devices for execution by at least one of the one or more processors via at least one of the one or more memories, to perform a search in a database and receive a total count of the search results data that matches the query; program instructions, stored on at least one of the one or more storage devices for execution by at least one of the one or more processors via at least one of the one or more memories, to divide the total count of the search results data into matches the query into pages; program instructions, stored on at least one of the one or more storage devices for execution by at least one of the one or more processors via at least one of the one or more memories, to determine how many pages of search results data to fetch; program instructions, stored on at least one of the one or more storage devices for execution by at least one of the one or more processors via at least one of the one or more memories, to fetch search results data for the determined number of pages and store the search results data for the determined number of pages in the repository; program instructions, stored on at least one of the one or more storage devices for execution by at least one of the one or more processors via at least one of the one or more memories, to display one page of fetched search results data and links to other pages of search results data to the user through the interface; program instructions, stored on at least one of the one or more storage devices for execution by at least one of the one or more processors via at least one of the one or more memories, to accept an action from the user selecting a page of search results data to display the links to other pages of search results data to the user through the interface; if the action selects a page of search results data which was not fetched, program instructions, stored on at least one of the one or more storage devices for execution by at least one of the one or more processors via at least one of the one or more memories, to fetch at least one page of non-fetched search results data and store in the repository and mark the search results data of the page of fetched search results data; and repeating from the program instructions, stored on at least one of the one or more storage devices for execution by at least one of the one or more processors via at least one of the one or more memories, to display the at least one page of fetched search results data and links to pages of search results data to the user through the interface.

### BRIEF DESCRIPTION OF THE SEVERAL VIEWS OF THE DRAWINGS

FIG. 1 depicts a pictorial representation of a network of computers in which illustrative embodiments may be implemented.

FIG. 2 shows an example of a browser interface displaying search result pages of fetched and non-fetched search results of a first embodiment.

FIG. 3 shows an example of a browser interface displaying search result pages of fetched and non-fetched search results of a second embodiment.

FIG. 4 shows a method of selectively fetching search results.

FIG. 5 shows illustrates internal and external components of a client computer and a server computer in which illustrative embodiments may be implemented.

### DETAILED DESCRIPTION

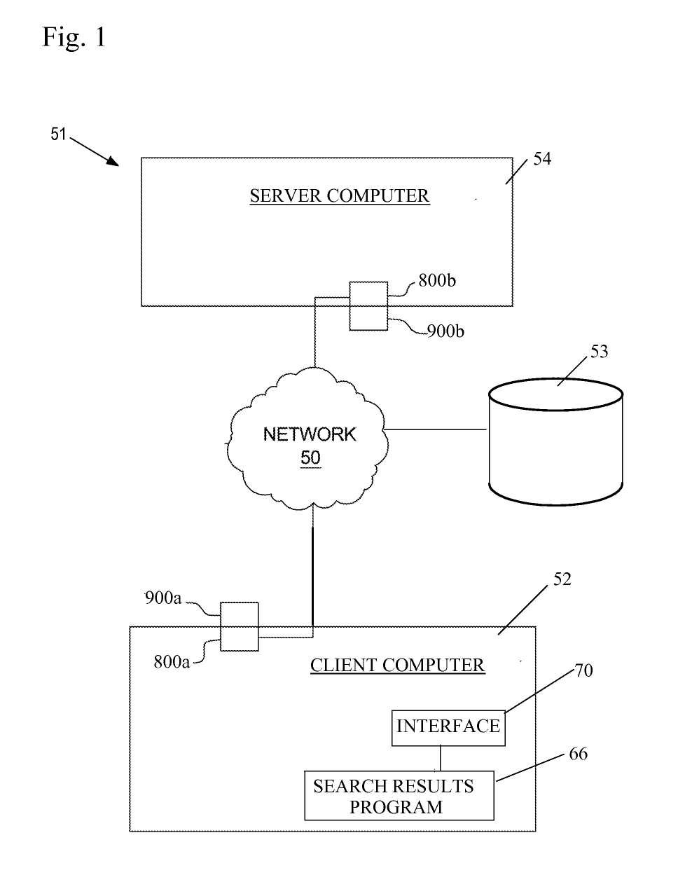

FIG. 1 is an exemplary diagram of a possible data processing environment provided in which illustrative embodiments may be implemented. It should be appreciated that FIG. 1 is only exemplary and is not intended to assert or imply any limitation with regard to the environments in which different embodiments may be implemented. Many modifications to the depicted environments may be made.

Referring to FIG. 1, network data processing system 51 is a network of computers in which illustrative embodiments may be implemented. Network data processing system 51 contains network 50, which is the medium used to provide communication links between various devices and computers connected together within network data processing system 51. Network 50 may include connections, such as wire, wireless communication links, or fiber optic cables.

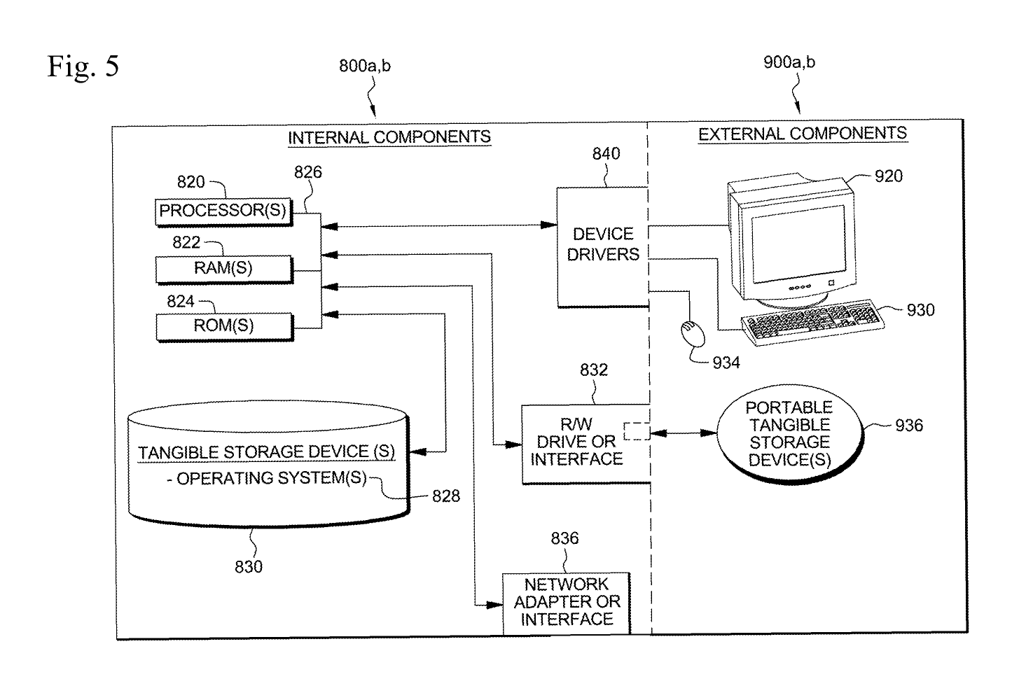

In the depicted example, client computer 52, tangible storage device 53, and server computer 54 connect to network 50. In other exemplary embodiments, network data processing system 51 may include additional client computers, storage devices, server computers, and other devices not shown. Client computer 52 includes a set of internal components 800a and a set of external components 900a, further illustrated in FIG. 5. Client computer 52 may be, for example, a mobile device, a cell phone, a personal digital assistant, a netbook, a laptop computer, a tablet computer, a desktop computer, or any other type of computing device. Client computer 52 may contain an interface 70. The interface 70 may accept commands and data entry from a user as well as display search results. The interface 70 can be, for example, a command line interface, a graphical user interface (GUI), or a web user interface (WUI) through which a user can access a network including a search results program 66 on either client computer 52 or server computer 54. Server computer 54 includes a set of internal components 800b and a set of external components 900b illustrated in FIG. 5.

In the depicted example, server computer 54 provides information, such as boot files, operating system images, and applications to a client computer 52. Server computer 54 can compute the information locally or extract the information from other computers on network 50.

Program code and programs such as a search results program 66 may also be located in network data processing system 51 and may be stored on at least one of one or more computer-readable tangible storage devices 830 shown in FIG. 5, on at least one of one or more portable computer-readable tangible storage devices 936 as shown in FIG. 5, on tangible storage device 53 connected to network 50, or downloaded to a data processing system or other device for use. For example, program code and programs such as a search results program 66 may be stored on at least one of one or more tangible storage devices 830 on server computer 54 and downloaded to client computer 52 over network 50 for use on client computer 52. Alternatively, server computer 54 can be a web server, and the program code, and programs such as an a search results program 66 may be stored on at least one of the one or more tangible storage devices 830 on server computer 54 and accessed on client computer 52. In other exemplary embodiments, the program code, and programs such as a search results program 66 may be stored on at least one of one or more computer-readable tangible storage devices 830 on client computer 52 or distributed between two or more servers.

In the depicted example, network data processing system 51 is the Internet with network 50 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 51 also may be implemented as a number of different types of networks, such as, for example, an intranet, local area network (LAN), or a wide area network (WAN). FIG. 1 is intended as an example, and not as an architectural limitation, for the different illustrative embodiments.

In an embodiment of the present invention, a network data processing system 51 may be configured to retrieve a limited number of search results from queries entered into an interface 70, such as a browser interface to the World Wide Web or other databases. The system limits the initial number of search results retrieved from the total count of search results that match a user entered query. The system also uses pagination to divide the total count of search results that match the user entered query into search result pages with a specific number of search results per page. The system may fetch only one page of search results or may fetch a predetermined number of search result pages.

After a user has demanded display of another page of already fetched search results or another page of non-fetched search result records through a user action, memory virtualization may be used to cache already fetched pages, alleviating the need to retrieve the search results records of that specific page from databases, such as the Internet. Alternatively, the data from previously fetched pages of search results may be disregarded when a user demands another page of search results through a user action. A user action includes but is not limited to selecting a specific link or touching on a touch screen a specific link.

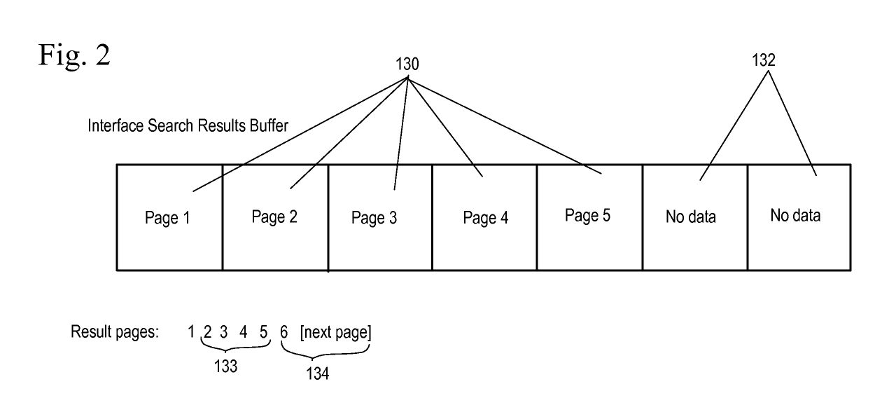

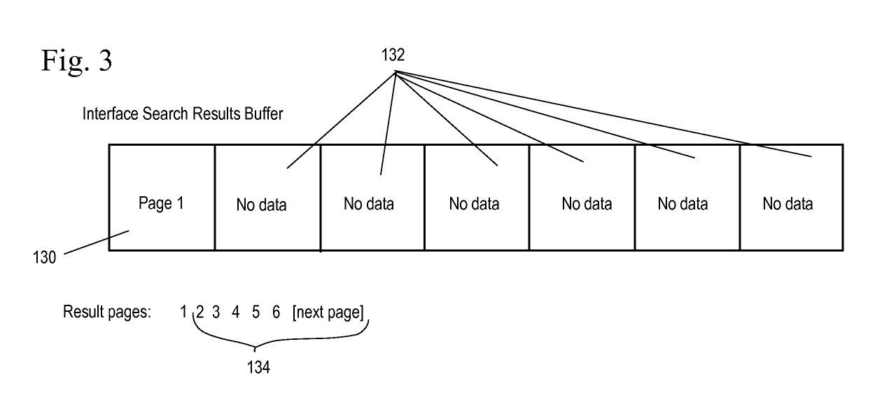

In one embodiment, the first page of search results are fetched and the remaining search result pages are not fetched unless demanded by the user through a user action as shown in FIG. 3. In another embodiment, a certain number of pages, for example five pages of search results are fetched and remaining pages of search results are not fetched as shown in FIG. 2 unless demanded by the user through a user action.

By not fetching all of the pages of search results, and only retrieving search results as demanded by a user action, the user device, for example client computer 52, decreases the time for executing and displaying search results of the search, decreases the data cached resulting in a decreased amount of memory used by the user device, and a decrease in the chances of receiving “time out” and “out of memory” errors. Additionally, the pages of search results that were fetched may be “paged out” or removed from the cache and the page(s) of search results requested by a user action may be “paged in”.

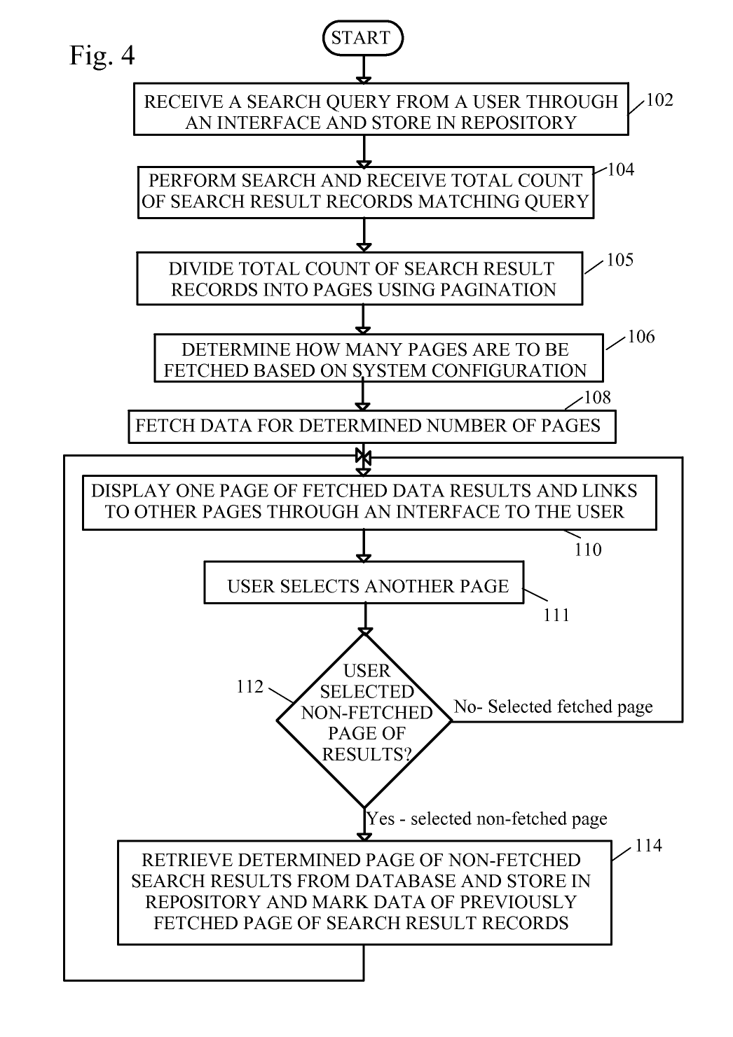

Referring to FIG. 4, a user enters a search query or search parameters into an interface, for example interface 70 of client computer 52, and the search query is stored in a repository (step 102). The repository may be repository 53, or tangible storage device 830, portable tangible storage device 936, or a computer readable storage medium which includes, but is not limited to a random access memory (RAM), a read-only memory (ROM), an erasable programmable read-only memory (EPROM or Flash memory), an optical fiber, a portable compact disc read-only memory (CD-ROM).

A search of the search query is performed in databases, for example by a program such as the search results program 66 in the World Wide Web, and the total count or number of search result records matching the query is received (step 104).

The total count of search result records is then divided into pages using pagination (step 105) to determine the total number of search result pages. The number of search results per page is based on system configuration of pagination parameters, e.g. number of search results per page, links to various other pages, etc. . . .

The number of pages to be fetched is determined based on the system configuration (step 106). In other words, the number of search results to actually be returned or fetched is limited or designated to be a specific number of records from the total available records matching the search query. The system configuration may include altering the number of designated records returned via direct Structured Query Language (SQL), through the search engine application programming interface (API), or through the use of database cursors per search query.

The data for the determined number of pages of search results is fetched from a database (step 108), such as the World Wide Web and stored in a repository.

A page of search results with fetched data results and links to other pages are displayed to a user through an interface (step 110), such as interface 70 of the client computer 52.

For example, if the total count of search results matching a search query is 60 records, and pagination settings divides the search results into 10 search result records per page, and the number of pages set to be fetched is 10 search result records, one page of search result records would be fetched and would display links to five other pages of search results through an interface. The five remaining pages would not have any data present.

The user selects another page through a user action (step 111).

If the user, through a user action, selects a link to a non-fetched page of search results (step 112), the data of the selected non-fetched page of search results is retrieved from a database and stored in a repository and the data of previously fetched page or pages of search result records is marked (step 114). The previously fetched pages of search results may be marked by the system to be discarded to “paged out” or alternatively, the previously fetched pages may be cached using memory virtualization, for example, to free up memory.

It should be noted that the user action of step 111 does not result in performing the search and retrieving all of the search results again, instead the user action retrieves only the search results for the page requested by the user action.

The method then returns to step 110 of displaying one page of fetched data results and links to other pages through an interface to the user.

If the user does not select a non-fetched page of search results, (step 112), return to step 110 of displaying one page of fetched data results and links to other pages through an interface to the user.

FIG. 2 shows an example of a browser interface displaying search result pages of fetched and non-fetched search results of a first embodiment. The user entered a search query into an interface and the search was performed. The total count or number of search results records matching the query search results is was received, for example seventy search result records. The seventy search result records are then divided into pages through pagination, for example ten search result records per page, resulting in seven pages of search results. The number of pages to be fetched 130 is determined, for example five pages (Page 1-Page 5) or fifty search result records.

The first page (Page 1) 130 of ten fetched search results would be displayed to a user along with links 133 to pages 130 with fetched search results (Pages 2-Pages 5) and links 134 to pages with non-fetched results 132 (Pages 6 and up). The non-fetched pages of results 132 are only loaded into memory if chosen through user action.

If a user selects a link 134 to another page 132 with non-fetched results through a user action, the previously fetched page or pages 130 are marked to have the data from the page or pages to be completely discarded or to cache the data through memory virtualization. The chosen non-fetched page of search results is retrieved from a database, stored in the repository or memory and displayed to the user through an interface.

FIG. 3 shows an example of a browser interface displaying search result pages of fetched and non-fetched search results of a second embodiment. The user entered a search query into an interface and the search was performed. The total count or number of search results records matching the query search results is was received, for example seventy search result records. The seventy search result records are then divided into pages through pagination, for example ten search result records per page, resulting in seven pages of search results.

The number of pages to be fetched 130 is determined, for example one page or ten search result records only. The first page (Page 1) of ten fetched search results would be stored in a repository or memory and displayed to a user along with links 134 to pages with non-fetched results 132. The non-fetched pages of results are only loaded into memory if chosen through user action.

If a user selects a link 134 to another page 132 with non-fetched results through a user action, the previously fetched page is marked to have the data from the page be completely discarded or to cache the data through memory virtualization. The chosen non-fetched page of search results is retrieved from a database, stored in a repository and displayed to the user through an interface.

FIG. 5 illustrates internal and external components of client computer 52 and server computer 54 in which illustrative embodiments may be implemented. In FIG. 5, client computer 52 and server computer 54 include respective sets of internal components 800a, 800b, and external components 900a, 900b. Each of the sets of internal components 800a, 800b includes one or more processors 820, one or more computer-readable RAMs 822 and one or more computer-readable ROMs 824 on one or more buses 826, and one or more operating systems 828 and one or more computer-readable tangible storage devices 830. The one or more operating systems 828 and search model programs 66 are stored on one or more of the computer-readable tangible storage devices 830 for execution by one or more of the processors 820 via one or more of the RAMs 822 (which typically include cache memory). In the embodiment illustrated in FIG. 5, each of the computer-readable tangible storage devices 830 is a magnetic disk storage device of an internal hard drive. Alternatively, each of the computer-readable tangible storage devices 830 is a semiconductor storage device such as ROM 824, EPROM, flash memory or any other computer-readable tangible storage device that can store a computer program and digital information.

Each set of internal components 800a, 800b also includes a R/W drive or interface 832 to read from and write to one or more portable computer-readable tangible storage devices 936 such as a CD-ROM, DVD, memory stick, magnetic tape, magnetic disk, optical disk or semiconductor storage device. A search results program 66 can be stored on one or more of the portable computer-readable tangible storage devices 936, read via R/W drive or interface 832 and loaded into hard drive 830.

Each set of internal components 800a, 800b also includes a network adapter or interface 836 such as a TCP/IP adapter card. A search results program 66 can be downloaded to computer 52 and server computer 54 from an external computer via a network (for example, the Internet, a local area network or other, wide area network) and network adapter or interface 836. From the network adapter or interface 836, a search results program 66 is loaded into hard drive 830. The network may comprise copper wires, optical fibers, wireless transmission, routers, firewalls, switches, gateway computers and/or edge servers.

Each of the sets of external components 900a, 900b includes a computer display monitor 920, a keyboard 930, and a computer mouse 940. Each of the sets of internal components 800a, 800b also includes device drivers 840 to interface to computer display monitor 920, keyboard 930 and computer mouse 940. The device drivers 840, R/W drive or interface 832 and network adapter or interface 836 comprise hardware and software (stored in storage device 830 and/or ROM 824).

A search results program 66 can be written in various programming languages including low-level, high-level, object-oriented or non object-oriented languages. Alternatively, the functions of a search results program 66 can be implemented in whole or in part by computer circuits and other hardware (not shown).

Based on the foregoing, a computer system, method, and program product have been disclosed for selectively fetching search results. However, numerous modifications and substitutions can be made without deviating from the scope of the present invention. Therefore, the present invention has been disclosed by way of example and not limitation.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

1. A method for selectively fetching search results data comprising the steps of:
a computer receiving a search query from a user through an interface and storing the search query in a repository;
the computer performing a search in a database and receiving a total count of the search results data that matches the query;
the computer dividing the total count of the search results data that matches the query into a total number of search results pages representative of the total count of the search results;
the computer determining how many of the total number of search results pages of search results data to fetch;
the computer fetching search results data for the determined number of pages from the total number of search results pages and storing the determined number of pages in the repository;
the computer displaying one page of fetched search results data and links to other pages of search results data to the user through the interface;
accepting an action from the user selecting a page of search results data to display from the links to other pages of search results data through the interface;
if the action selects a page of search results data which was not fetched, the computer fetching at least one page of non-fetched search results data and storing the search results data in the repository and marking the search results data of the page of the fetched search results data; and
repeating the method from the step of the computer displaying one page of fetched search results data and links to other pages of search results data to the user through the interface.

2. The method of claim 1, wherein the marked search results data of the page of fetched results is discarded.

3. The method of claim 1, wherein the marked search results data of the page of fetched results is cached using memory virtualization and stored in the repository.

4. The method of claim 1, wherein the determined number of pages to fetched is one

5. The method of claim 1, wherein the determined number of pages to be fetched is greater than one.

6. A computer program product comprising a computer readable storage device storing a plurality of computer-readable computer-readable program instructions and when executed by one or more processors, performing the steps of claim 1.

7. A computer system comprising one or more processors, one or more computer-readable memories, one or more computer-readable, storage devices and program instructions which are stored on the one or more storage devices for execution by the one or more processors via the one or more memories and when executed by the one or more processors performing all the steps of claim 1.

8. A computer program product for selectively fetching search results, the computer program product comprising:
a computer readable storage device storing a plurality of computer readable program instructions to:
receive a search query from a user through an interface and store the search query in a repository;
perform a search in a database and receive a total count of the search results data that matches the query;
divide the total count of the search results data that matches the query into a total number of search results pages representative of the total count of the search results;
determine how many of the total number of search results pages of search results data to fetch;
fetch search results data for the determined number of pages from the total number of search results pages and store the search results data for the determined number of pages in the repository;
display one page of fetched search results data and links to other pages of search results data to the user through the interface;
accept an action from the user selecting a page of search results data to display from the links to other pages of search results data to the user through the interface;
if the action selects a page of search results data which was not fetched, fetching at least one page of non-fetched search results data and store in the repository and mark the search results data of the page of fetched search results data; and
repeating from the program instructions, to display the at least one page of fetched search results data and links to pages of search results data to the user through the interface.

9. The program product of claim 8, wherein the marked search results data of the page of fetched results is discarded.

10. The program product of claim 8, wherein the marked search results data of the page of fetched results is cached using memory virtualization and stored in the repository.

11. The program product of claim 8, wherein the determined number of pages to fetched is one

12. The program product of claim 8, wherein the determined number of pages to be fetched is greater than one.

13. A computer system for selectively fetching search results, the computer system comprising:
one or more processors, one or more computer-readable memories and one or more computer-readable, storage devices;
program instructions, stored on at least one of the one or more storage devices for execution by at least one of the one or more processors via at least one of the one or more memories, to receive a search query from a user through an interface and store the search query in a repository;
program instructions, stored on at least one of the one or more storage devices for execution by at least one of the one or more processors via at least one of the one or more memories, to perform a search in a database and receive a total count of the search results data that matches the query;
program instructions, stored on at least one of the one or more storage devices for execution by at least one of the one or more processors via at least one of the one or more memories, to divide the total count of the search results data into matches the query into a total number of search results pages representative of the total count of the search results;
program instructions, stored on at least one of the one or more storage devices for execution by at least one of the one or more processors via at least one of the one or more memories, to determine how many of the total number of search results pages of search results data to fetch;
program instructions, stored on at least one of the one or more storage devices for execution by at least one of the one or more processors via at least one of the one or more memories, to fetch search results data for the determined number of pages from the total number of search results pages and store the search results data for the determined number of pages in the repository;
program instructions, stored on at least one of the one or more storage devices for execution by at least one of the one or more processors via at least one of the one or more memories, to display one page of fetched search results data and links to other pages of search results data to the user through the interface;
program instructions, stored on at least one of the one or more storage devices for execution by at least one of the one or more processors via at least one of the one or more memories, to accept an action from the user selecting a page of search results data to display the links to other pages of search results data to the user through the interface;
if the action selects a page of search results data which was not fetched, program instructions, stored on at least one of the one or more storage devices for execution by at least one of the one or more processors via at least one of the one or more memories, to fetch at least one page of non-fetched search results data and store in the repository and mark the search results data of the page of fetched search results data; and
repeating from the program instructions, stored on at least one of the one or more storage devices for execution by at least one of the one or more processors via at least one of the one or more memories, to display the at least one page of fetched search results data and links to pages of search results data to the user through the interface.

14. The system of claim 13, wherein the marked search results data of the page of fetched results is discarded.

15. The system of claim 13, wherein the marked search results data of the page of fetched results is cached using memory virtualization and stored in the repository.

16. The system of claim 13, wherein the determined number of pages to fetched is one

17. The system of claim 13, wherein the determined number of pages to be fetched is greater than one.
